(19) United States
(12) Patent Application Publication
(10) Pub. No.: US 2011/0142291 A1
(43) Pub. Date: Jun. 16, 2011

(54) Method and Apparatus for Processing Digital Image and Computer Readable Recording Medium

(75) Inventors: Eun-sun Ahn, Suwon-si (KR); Won-seok Song, Anyang-si (KR)

(73) Assignee: SAMSUNG ELECTRONICS CO., LTD., Suwon-si (KR)

(21) Appl. No.: 12/969,965

(22) Filed: Dec. 16, 2010

(30) Foreign Application Priority Data
Dec. 16, 2009 (KR) 10-2009-0125688

(51) Int. Cl. G06K 9/00

(52) U.S. Cl. 382/107

(57) ABSTRACT

An apparatus for processing a digital image includes a digital signal processor (DSP) that determines motions of different types based on motion information obtained by matching blocks of time-differential images and that determines whether a tripod had been used based on the determined motions.

### CROSS-REFERENCE TO RELATED PATENT APPLICATION

This application claims the priority benefit of Korean Patent Application No. 10-2009-0125688, filed on Dec. 16, 2009, in the Korean Intellectual Property Office, the disclosure of which is incorporated herein in its entirety by reference.

### BACKGROUND

1. Field of the Invention

Embodiments relate to a method and an apparatus for processing digital images and a computer readable recording medium having recorded thereon a program executable by a processor for performing the method of processing digital images.

2. Description of the Related Art

A digital apparatus capable of capturing still images or motion pictures, such as a digital image processor or a camcorder, may determine whether a tripod had been used and whether a motion occurred in a captured image based on input images without using a separate hardware device, and performs different image processes based on the determination.

However, when a digital image processor captures an image while mounted on a tripod, if a motion occurs in the image, it is generally determined that no tripod had been used. Such a problem occurs not only because input images are used for the determination, but also because motions of different types cannot be distinguished by the digital image processor.

### SUMMARY

Embodiments include a method for determining whether a tripod had been used for capturing an image by distinguishing a motion of a portion of an image from a motion due to shaking of a digital image processor.

According to an embodiment, a digital image processing apparatus includes a digital signal processor (DSP) that determines motions of different types based on motion information obtained by matching blocks of time-differential images and that determines whether a tripod had been used based on the determined motions.

According to another embodiment, a method of controlling a digital image processing apparatus includes obtaining motion information by matching blocks of time-differential images; determining whether there is a global motion indicating movement of a digital image capturing apparatus, a local motion indicating movement of a portion of an image, or both, based on the obtained motion information; and determining whether a tripod had been used based on the determined motion.

According to another embodiment, a non-transitory computer readable storage medium has stored thereon a computer program executable by a processor for performing a method of controlling a digital image processing apparatus. The method includes determining a global motion indicating movement of a digital image capturing apparatus and a local motion indicating movement of a portion of an image based on motion information obtained by matching blocks of time-differential images, and determining whether a tripod had been used based on the determined motion.

### BRIEF DESCRIPTION OF THE DRAWINGS

The above and other features and advantages will become more apparent by describing in detail exemplary embodiments with reference to the attached drawings in which:

FIG. 1 is a diagram showing a structure of a digital image capturing apparatus for embodying an apparatus and a method for processing digital images, according to an embodiment;

FIG. 2 is a diagram showing a digital signal processor (DSP) of FIG. 1 in greater detail, according to an embodiment;

FIGS. 3A and 3B are diagrams for describing a splitting unit shown in FIG. 2, according to an embodiment;

FIGS. 4A, 4B, and 4C are diagrams for describing a detecting unit shown in FIG. 2, according to an embodiment;

FIGS. 5A, 5B, 5C, and 5D are diagrams for describing a calculating unit shown in FIG. 2, according to an embodiment;

FIGS. 6A, 6B, and 6C are diagrams showing a case in which it is determined that a tripod had been used, according to an embodiment;

FIGS. 7A, 7B, and 7C are diagrams showing a case in which it is determined that a tripod had not been used, according to an embodiment;

FIG. 8 is a flowchart of a method of controlling a digital image processing apparatus, according to an embodiment;

FIG. 9 is a detailed flowchart of a method of detecting locations of motions of image blocks of a previous image in comparison with a current image, according to an embodiment;

FIG. 10 is a detailed flowchart of a method of quantizing motion vectors and measuring frequencies of the motion vectors, according to an embodiment; and

FIG. 11 is a detailed flowchart of a method of determining types of motions and a method of determining whether a tripod had been used, according to an embodiment.

### DETAILED DESCRIPTION

Embodiments will now be described more fully with reference to the accompanying drawings. The invention may, however, be embodied in many different forms and should not be construed as being limited to the embodiments set forth herein; rather, these embodiments are provided so that this disclosure will convey the concepts of the invention to those of ordinary skill in the art.

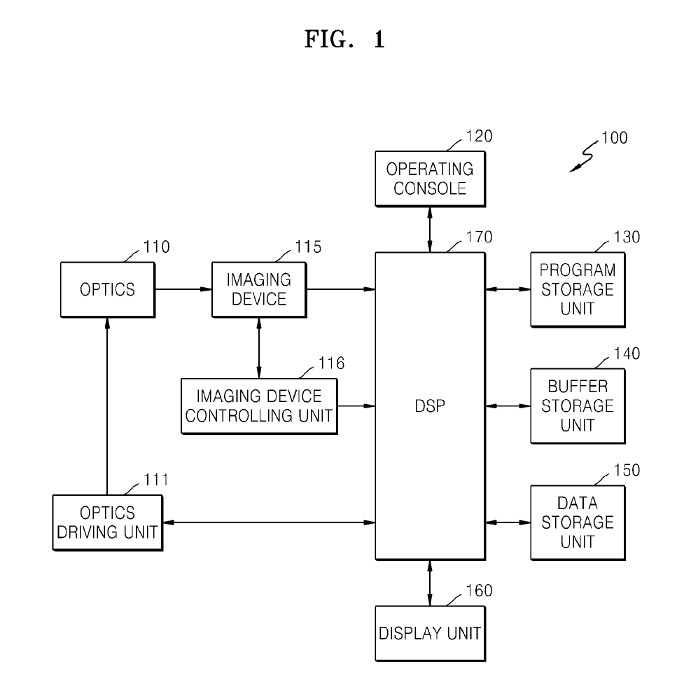

FIG. 1 is a diagram showing a structure of a digital image capturing apparatus 100 for embodying an apparatus and a method for processing digital images, according to an embodiment.

The digital image capturing apparatus 100 may include optics 110, an optics driving unit 111, an imaging device 115, an imaging device controlling unit 116, an operating console 120, a program storage unit 130, a buffer storage unit 140, a data storage unit 150, a display unit 160, and a digital signal processor (DSP) 170.

The optics 110 provides optical signals input from an object to the imaging device 115. The optics 110 may include at least one lens, e.g., a zoom lens for widening/narrowing an imaging angle and a focusing lens for focusing on the object. Furthermore, the optics 110 may further include an iris for controlling light intensity.

The optics driving unit 111 controls positions of lenses, an aperture of an iris, etc. The optics driving unit 111 may adjust focus by changing the positions of the lenses. Furthermore, the optics driving unit 111 may adjust light intensity by controlling the aperture of the iris. The optics driving unit 111 may control the optics 110 based on either control signals automatically generated according to image signals that are input in real-time or control signals manually input by a user.

Optical signals transmitted through the optics 110 form an image of the object on a light receiving surface of the imaging device 115. The imaging device 115 may be a charge-coupled device (CCD) or a complementary metal oxide semiconductor image sensor (CIS) that converts optical signals into digital signals. The imaging device controlling unit 116 may adjust sensitivity of the imaging device 115. The imaging device controlling unit 116 may control the imaging device 115 based on either control signals automatically according to image signals that are input in real-time or control signals manually input by a user.

The operating console 120 is a unit via which control signals may be input from an outside source (e.g., a user). The operating console 120 includes a shutter-release button for inputting a shutter-release signal for capturing an image by exposing the imaging device 115 to light for a predetermined amount of time, a power button for powering on or off the digital image capturing apparatus 100, a wide angle zoom button and a telescopic zoom button for respectively widening and narrowing the imaging angle, and various other buttons, such as buttons for inputting texts, buttons for selecting an image capturing mode or an playback mode, buttons for configuring white balance, buttons for configuring exposure, etc. As described above, the operating console 120 may be embodied as various buttons. However, this should not be construed as limiting, and the operating console 120 may be embodied as any type of input device by which a user may input control signals; e.g., a keyboard, a touchpad, a touch screen, or a remote control.

Furthermore, the digital image capturing apparatus 100 includes the program storage unit 130 that stores programs, such as an operating system for driving the digital image capturing apparatus 100 and application systems, the buffer storage unit 140 that temporarily stores data required during calculations and stores result data, and the data storage unit 150 that stores image files containing image signals and stores various information required by the programs.

Furthermore, the digital image capturing apparatus 100 includes the display unit 160 that displays an operating status of the digital image capturing apparatus 100 or information regarding an image captured by the digital image capturing apparatus 100. The display unit 160 may provide visual and/or auditory information to a user. For example, the display unit 160 may include a liquid crystal display (LCD) panel, an organic light emitting diode (OLED) display panel, or an electrophoretic display device (EDD) panel.

Furthermore, the digital image capturing apparatus 100 includes the DSP 170 that processes input image signals and controls each component of the digital image capturing apparatus 100 based on the processed image signals or externally input signals.

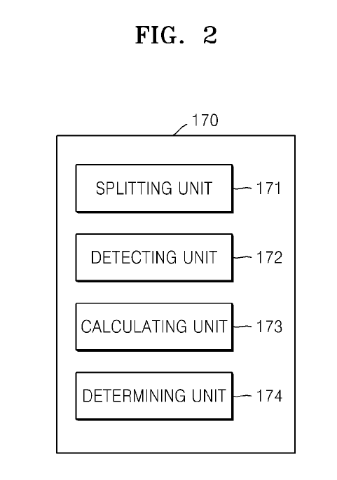

FIG. 2 is a diagram showing the DSP 170 of FIG. 1 in greater detail, according to an embodiment. In some embodiments, the DSP 170 may perform digital signal processing, such as gamma correction and white balance adjustment. Furthermore, as shown in FIG. 2, the DSP 170 may include various components, such as a splitting unit 171, a detecting unit 172, a calculating unit 173, and a determining unit 174. Various modifications may be made herein; e.g., the splitting unit 171, the detecting unit 172, the calculating unit 173, and the determining unit 174 may be components formed separate from the DSP 170. Detailed descriptions of operations of the components described above will be given below.

Hereinafter, operations of the DSP 170 will be described with reference to FIGS. 2 through 7.

The DSP 170 determines motions of different types based on motion information obtained by matching blocks of time-differential images, and determines whether a tripod had been used based on the determined motion types. The DSP 170 includes the splitting unit 171, the detecting unit 172, the calculating unit 173, and the determining unit 174. Different types of motions that are determined may include a global motion indicating movement of a digital image capturing apparatus and a local motion indicating movement of a portion of an image.

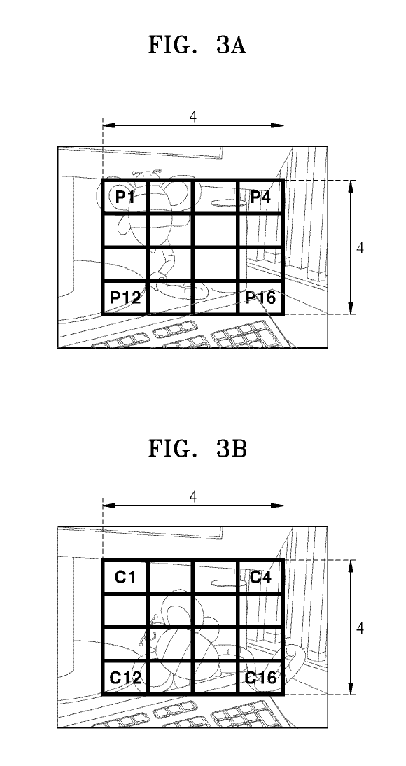

FIGS. 3A and 3B are diagrams for describing a splitting unit shown in FIG. 2, according to an embodiment. The splitting unit 171 splits time differential images, e.g., a previous image and a current image, into a predetermined number of blocks. FIG. 3A shows an example in which a previous image is split into 4×4 blocks, that is, 16 blocks P1 through P16, and FIG. 3B shows an example in which a current image is split into 4×4 blocks, that is, 16 blocks C1 through C16.

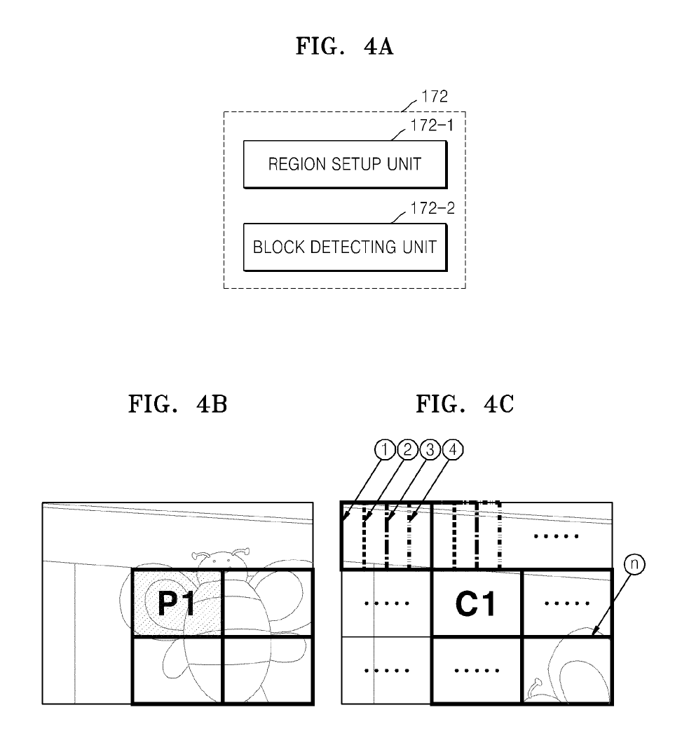

FIGS. 4A, 4B, and 4C are diagrams for describing a detecting unit shown in FIG. 2, according to an embodiment. The detecting unit 172 detects a reference block within a predetermined region of the current image by using a selected block of the previous image as a reference block of the previous image. The detecting unit 172 includes a region setup unit 172-1 and a block detecting unit 172-2 as shown in FIG. 4A.

The region setup unit 172-1 sets up a region around a block of the current image that is located at the same location as a reference block in the previous image. FIG. 4B shows an example in which a region is set up around a block (e.g. P1) selected in a previous image, and FIG. 4C shows an example in which a region is set up around a block (e.g. C1) of a current image, in which the block C1 of the current image is located at the same location as the block P1 in the previous image.

The block detecting unit 172-2 detects which block in the region set by the region setup unit 172-1 in the current image is the most similar to the reference block of the previous image, by using a sum of absolute differences (SAD) within the set region in the current image. Equation 1 below is an equation for calculating a SAD.

$$SAD = {\sum }_{n = - L}^{L} {\sum }_{m = - L}^{L} \vert {( Previous Image Block )}_{x + n , y + m} - {( Current Image Block )}_{x + n , y + m} \vert \qquad [ Equation 1 ]$$

SAD values are calculated with respect to split windows of the blocks (\textcircled{1} through \textcircled{n} in FIG. 4C) in the region set by the region setup unit 172-1, and a block having the smallest SAD value may be considered as the block that is the most similar to the reference block of the previous image.

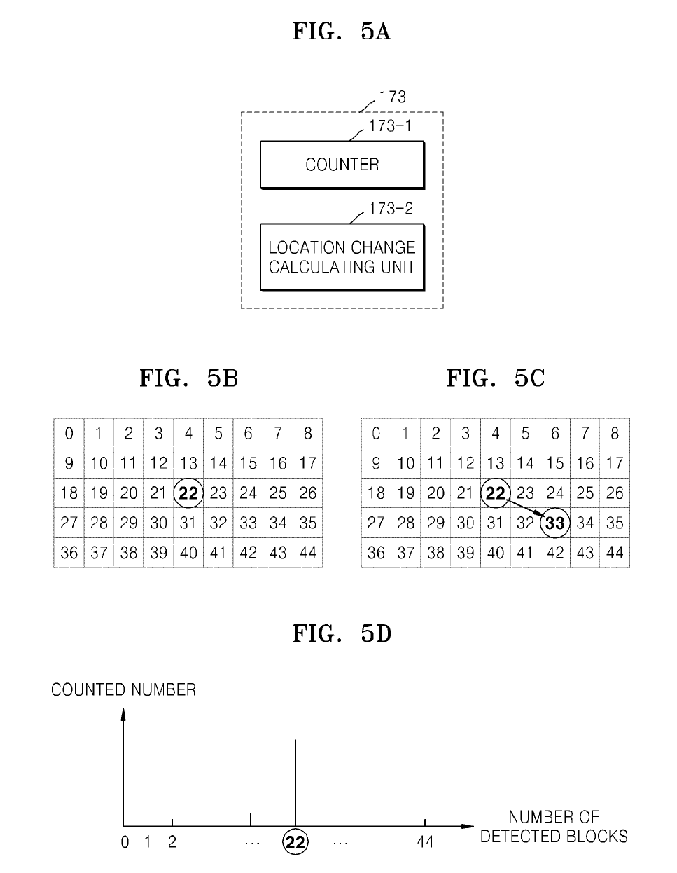

FIGS. 5A, 5B, 5C, and 5D are diagrams for describing a calculating unit shown in FIG. 2, according to an embodiment. The calculating unit 173 calculates motion vectors of the blocks of the current image with respect to the blocks of the previous image by referring to the blocks that are the most similar to the blocks of the previous image detected by the detecting unit 172 and frequencies of the motion vectors. For the calculations, the calculating unit 173 includes a counter 173-1 and a location change calculating unit 173-2 as shown in FIG. 5A.

The counter 173-1 counts a number of blocks having the smallest SAD value from all of the blocks (4×4) of the current image.

The location change calculating unit 173-2 calculates the motion vectors of the counted blocks of the current image by comparing the counted blocks of the current image to the corresponding blocks in the previous image.

The calculation is performed by using a method of finding a motion vector by using the SAD values obtained via the block detecting unit 172-2. Equation 2 below is an equation for finding a motion vector.

$$Motion Vector = Min ( \begin{matrix}\vert Reference Block ( P 1 ) \vert , \\ \vert Reference Block ( P 1 ) \vert \\ \vert Reference Block ( P 1 ) \vert \\ \vert Reference Block ( P 1 ) \vert \\ ⋮ \\ \vert Reference Block ( P 1 ) \vert\end{matrix} ) \qquad [ Equation 2 ]$$

In an example in which the width and the length of the region set up by the region setup unit 172-1 are 9 and 5, respectively, the value of \textcircled{n} is 45, and the motion vectors may be estimated with reference to FIGS. 5B and 5C.

As illustrated in FIG. 5B, in an example in which a reference block of the previous image is centered at a location 22 and a block of the current image having the smallest SAD value is at a location 33, it may be determined that the reference block P1 has moved from the location 22 to the location 33 in the current image, as shown in FIG. 5C.

Distributions of motions determined for each of the blocks in the current image may be as shown in a 2D histogram shown in FIG. 5D. Here, a horizontal axis indicates quantized motion vector detected in a block, and a vertical axis indicates frequency of a motion vector. In the histogram shown in FIG. 5D, most a of matched blocks have a value of 22, which means that no motion occurred in most of the blocks.

The determining unit 174 determines whether there is a local motion in a current image based on the frequency of blocks having the smallest SAD value, and determines whether a tripod had been used with respect to the motion determined based on the motion vectors of the blocks.

The determining unit 174 determines that there is no local motion when the frequency of the most frequent motion vector is equal to or greater than a first reference value (e.g. 99% of the entire image). When it is determined that there is no local motion and the most frequent block has a value of 22, it is determined that there is no global motion and a tripod had been used. If it is determined that the most frequent motion vector does not have a value of 22, it is determined that there is a global motion and no tripod had been used.

When the frequency of the most frequent block is between the first reference value and a second reference value (e.g. between 85% and 99% of the entire image), the determining unit 174 determines that there is a local motion. When it is determined that there is a local motion and the most frequent motion vector has a value of 22, it is determined that there is no global motion and a tripod had been used. If it is determined the most frequent motion vector does not have a value of 22, it is determined that there is a global motion and no tripod had been used.

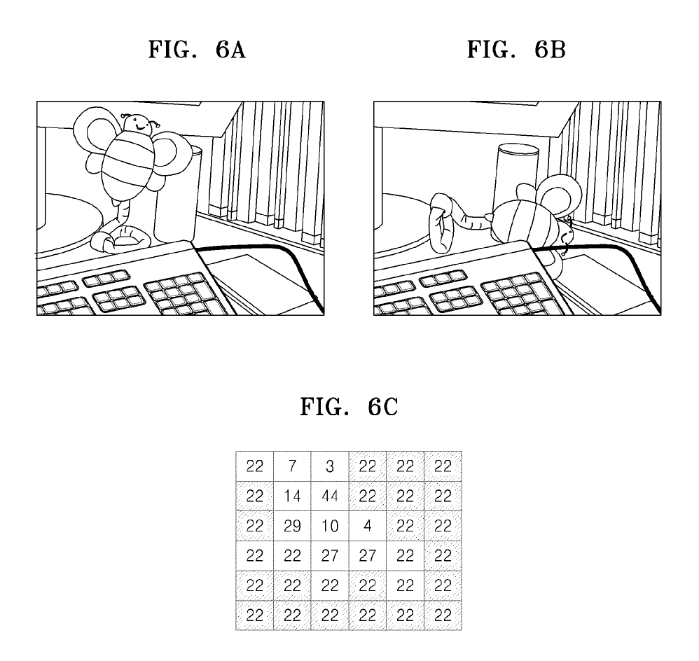

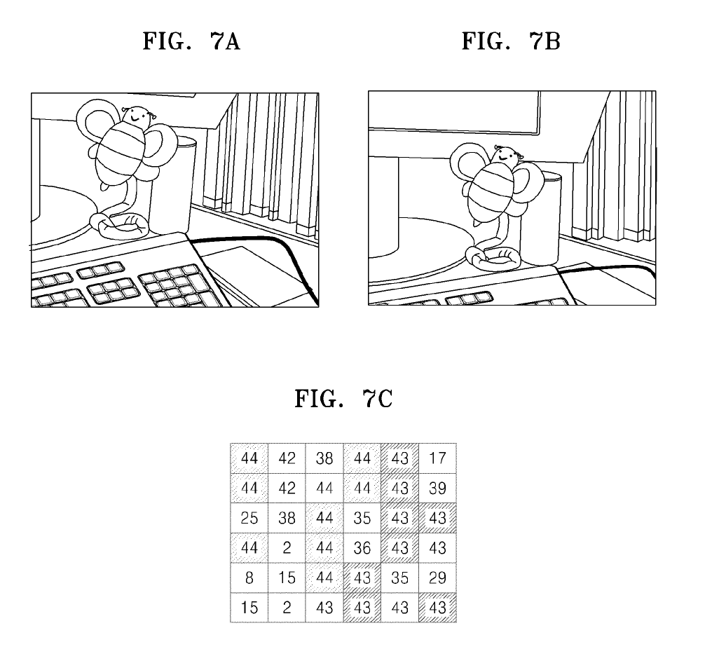

FIGS. 6A, 6B, and 6C are diagrams showing a case in which it is determined that a tripod had been used, according to an embodiment. FIGS. 7A, 7B, and 7C are diagrams showing a case in which it is determined that a tripod had not been used, according to an embodiment. According to a method of determining whether a tripod had been used in the prior art, it is determined that no tripod had been used when a motion occurs without determining types of the motion (a local motion or a global motion). However, according various embodiments as described herein, it may be determined whether a tripod had been used by determining types of motions in an image.

In other words, since a local motion shown in FIGS. 6A and 6B corresponds to a case in which a digital image capturing apparatus is mounted on a tripod and only an object (butterfly) moves, it should be determined that a tripod had been used. As an example, when FIG. 6A shows a previous image and FIG. 6B shows a current image, the most frequent motion vector has a value of 22 and the frequency thereof is between 85% and 99% of the entire image as shown in FIG. 6C, and thus it may be determined that there is a local motion. At this point, since the most frequent motion vector has a value of 22, which indicates a center region of a block, it may be determined that there is no global motion and a tripod had been used.

As another example, when FIG. 7A shows a previous image and FIG. 7B shows a current image, the most frequent motion vector has a value of 43 and the frequency thereof is not between 85% and 99% of the entire image as shown in FIG. 7C, and thus it may be determined that there is no local motion. At this point, since the most frequent motion vector has a value of 43, which does not indicate a center region of a block, it may be determined that there is a global motion and no tripod had been used.

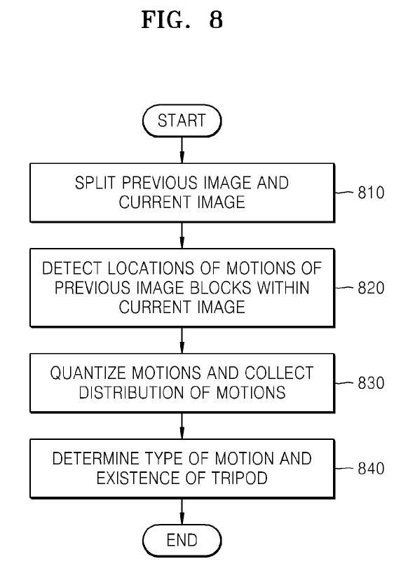

Hereinafter, a method of controlling a digital image processor according to an embodiment will be described with reference to FIGS. 8 through 11. The method of controlling a digital image processor according to the present embodiment may be performed within a digital image processing apparatus as shown in FIG. 1. According to various embodiments, a main algorithm of the method of controlling a digital image processor may be performed within the DSP 170, aided by other components in the digital image processing apparatus.

FIG. 8 is a flowchart of a method of controlling a digital image processing apparatus, according to an embodiment. The DSP 170 splits time-differential images, e.g., a previous image and a current image, into a predetermined number of blocks (operation 810). FIG. 3A shows an example where a previous image is split into 4×4 blocks, that is, 16 blocks P1 through P16, and FIG. 3B shows an example where a current image is split into 4×4 blocks, that is, 16 blocks C1 through C16.

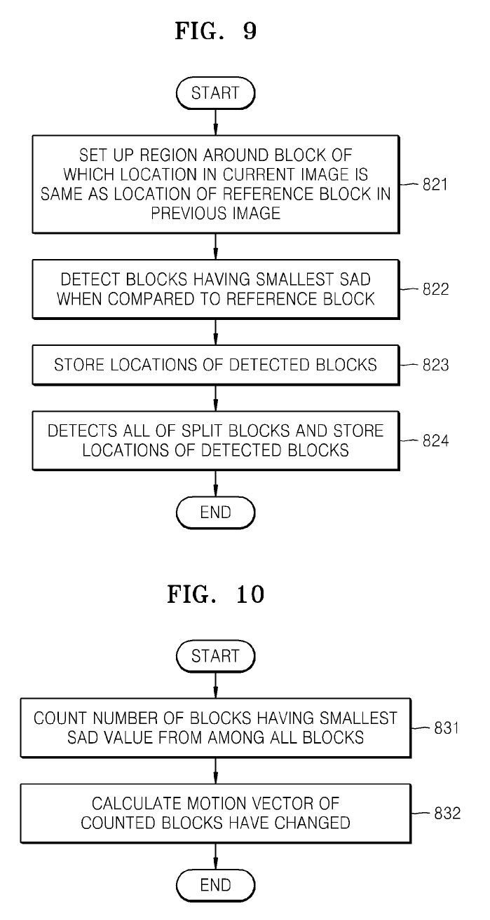

After the splitting of blocks, the DSP 170 detects locations of motions of image blocks of the previous image within the current image (operation 820). FIG. 9 is a detailed flowchart of a method of detecting locations of motions of image blocks of a previous image in comparison with a current image, according to an embodiment.

The DSP 170 sets up a region around a block of a current image that is in the same location as a reference block of a previous image (operation 821). FIG. 4B shows an example in which a region is set around a block (e.g., P1) selected in a previous image, and FIG. 4C shows an example in which a region is set around a block (e.g. C1) of a current image that is in the same location as the selected block of a previous image.

After the setting of the regions, the DSP 170 detects a block in the current image that is the most similar to the reference block by using SAD values within the set region in the current image (operation 822). Equation 1 above is an equation for calculating a SAD value. SAD values are calculated with respect to split windows of the blocks (\textcircled{1} through \textcircled{n} in FIG. 4C) in the set region of the current image, and a block having the smallest SAD value may be considered as the block that is the most similar to the reference block.

The DSP 170 stores the locations of the detected block (operation 823).

The DSP 170 detects all of the split blocks of the current image, and stores the locations of the detected blocks (operation 824).

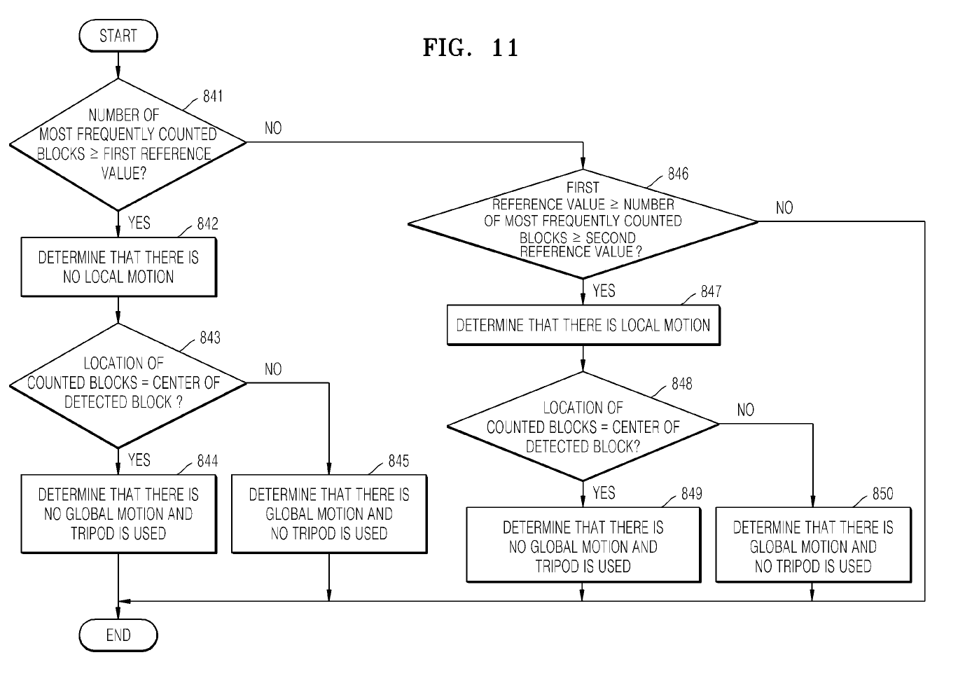

After the locations of motions are detected, the DSP 170 quantizes motion vectors and measures frequencies of the motion vectors (operation 830). FIG. 10 is a detailed flowchart of a method of quantizing motion vectors and measuring frequencies of the motion vectors, according to an embodiment.

The DSP 170 counts a number of blocks having the smallest SAD value from among all of the blocks (operation 831).

After the counting of the number of blocks having the smallest SAD value, the DSP 170 calculates motion vector of the counted blocks have changed with respect to the locations of the corresponding blocks in the previous image (operation 832). In an example where the width and the length of a region set up by the region setup unit 172-1 are 9 and 5, respectively, the value of \textcircled{n} will be 45, and amount of location change may be estimated with reference to FIGS. 5B and 5C. In FIG. 5B, in an example in which the center 22 of the reference block P1 in the previous image is the center and the location of a block having the smallest SAD value is 33, it may be determined that the reference block P1 is moved from 22 to 33 in the current image, as shown in FIG. 5C. Distributions of motions determined for each of the blocks in the entire image may be confirmed in the 2D histogram shown in FIG. 5D. Here, the horizontal axis indicates quantized amount of motion according to detected block, and the vertical axis indicates a counted number of matched blocks. In the histogram shown in FIG. 5D, most of the matched blocks have the value 22, which means that no motion occurred in most of the blocks.

After the quantization of the motion vectors and the measuring of the frequencies of the motion vectors, the DSP 170 determines types of motions and determines whether a tripod had been used (operation 840). FIG. 11 is a detailed flowchart of a method of determining types of motions and a method of determining whether a tripod had been used, according to an embodiment.

For determination of types of motions, the DSP 170 determines whether the most frequent motion vector in the current image is equal to or greater than a first reference value (operation 841). In the example illustrated with reference to FIGS. 5A-5D, the first reference value may be 99% of the entire image.

When the most frequent motion vector in the current image is equal to or greater than the first reference value, the DSP 170 determines that there is no local motion (operation 842).

When there is no local motion, the DSP 170 determines whether the most frequent motion vector does not indicate a center region of a corresponding block (operation 843). In the example illustrated with reference to FIGS. 5A-5D, when the most frequent motion vector indicates a center region of a corresponding block, position of the motion vectors have a value of 22.

When the most frequent motion vector indicates a center region of a corresponding block, the DSP 170 determines that there is no global motion and a tripod had been used (operation 844).

When the most frequent motion vector does not indicate a center region of a corresponding block, the DSP 170 determines that there is a global motion and no tripod had been used (operation 845).

Next, the DSP 170 determines whether the frequency of the most frequent motion vector is between the first reference value and a second reference value (operation 846). In the example illustrated with reference to FIGS. 5A-5D, the second reference value may be 85% of the entire image.

In a case where the frequency of the most frequent motion vector is between the first reference value and the second reference value, the DSP 170 determines that there is a local motion (operation 847).

When there is a local motion, the DSP 170 determines whether the most frequent motion vector indicates the center region of a corresponding block (operation 848). In the example illustrated with reference to FIGS. 5A-5D, when the most frequent motion vector indicates a center region of a corresponding block, position of the motion vector has a value of 22.

In a case where the most frequent motion vector indicates a center region of a corresponding block, the DSP 170 determines that there is no global motion and a tripod had been used (operation 849).

However, when the most frequent motion vector does not indicate a center region of a corresponding block, the DSP 170 determines that there is a global motion and no tripod had been used (operation 850).

According to a method of determining whether a tripod had been used in the prior art, it is determined that no tripod had been used in a case where a motion occurs without determining types of the motion (a local motion or a global motion). However, according the various embodiments described herein, it may be determined whether a tripod had been used by determining motion types in an image.

As described above, according to an embodiment, a motion of a portion of an image and a motion due to shake of a digital image processor may be distinguished, and thus it may be determined whether a tripod had been used for capturing an image.

Therefore, scene detecting efficiency may be improved, and images with improved quality may be obtained by performing different image processes to different scenes.

Embodiments may take the form of an entirely hardware embodiment, an entirely software embodiment or an embodiment combining software and hardware aspects. For example, embodiments may take the form of a computer program performing operations of each of the components described above and may be implemented as the DSP 170 that executes the computer program stored in the storage unit 130.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. It will be recognized that the terms “comprising,” “including,” and “having,” as used herein, are specifically intended to be read as open-ended terms of art.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. A digital image processing apparatus comprising a digital signal processor (DSP) that determines motions of different types based on motion information obtained by matching blocks of time-differential images and that determines whether a tripod had been used based on the determined motions.

2. The digital image processing apparatus of claim 1, wherein the types of motions are a global motion indicating movement of the digital image capturing apparatus and a local motion indicating movement of a portion of an image.

3. The digital image processing apparatus of claim 2, wherein the DSP comprises:
a splitting unit that splits a previous image and a current image into a predetermined number of blocks;
a detecting unit that a detects a reference block that corresponds to a block selected in the previous image, within a predetermined region of the current image;
a calculating unit that calculates a motion vector of a block that is most similar to the reference block and calculates frequencies of the motion vectors, for all blocks in the current image; and
a determining unit that determines whether there is a local motion in the current image based on the frequency of a most frequent motion vector among the motion vectors and determines whether a tripod had been used based on the determined motion.

4. The digital image processing apparatus of claim 2, wherein the detecting unit comprises:
a region setup unit that sets up a region around a block of the current image that is located where the reference block in the previous image is located; and
a block detecting unit that detects a block that is most similar to the reference block based on sum of absolute differences (SAD) within the set region.

5. The digital image processing apparatus of claim 2, wherein the calculating unit comprises:
a counter that counts a number of blocks detected from among the entire blocks, the detected blocks that are the most similar to the reference block; and
a location change calculating unit that calculates amount of change in locations of the counted blocks in the current image as compared to locations of the blocks in the previous image.

6. The digital image processing apparatus of claim 5, wherein, when the frequency of a most frequent motion vector among the motion vectors is equal to or greater than a first reference value, the determining unit determines that there is no local motion,
when it is determined that there is no local motion and the most frequent motion vector indicates no motion, the determining unit determines that there is no global motion and a tripod had been used, and
when it is determined that there is no local motion and the most frequent motion vector indicates motion, the determining unit determines that no tripod had been used.

7. The digital image processing apparatus of claim 6, wherein, when the frequency of the most frequent motion vector is between the first reference value and a second reference value, the determining unit determines that there is a local motion,
when it is determined that there is a local motion and the most frequent motion vector indicates no motion, the determining unit determines that there is no global motion and a tripod had been used, and
when it is determined that there is a local motion and the most frequent motion vector indicates motion, the determining unit determines that there is a global motion and no tripod had been used.

8. A method of controlling a digital image processing apparatus, the method comprising:
obtaining motion information by matching blocks of time-differential images;
determining whether there is a global motion indicating movement of a digital image capturing apparatus, a local motion indicating movement of a portion of an image, or both, based on the obtained motion information; and
determining whether a tripod had been used based on the determined motion.

9. The method of claim 8, wherein the obtaining of the motion information comprises:
splitting a previous image and a current image into a predetermined number of blocks;
detecting a reference block that corresponds to a block selected in the previous image, within a predetermined region of the current image;
calculating a motion vector of a block that is most similar to the reference block; and
calculating frequencies of the motion vectors, for all blocks in the current image.

10. The method of claim 9, wherein the determining of whether a tripod had been used comprises:
determining whether there is a local motion in the current image based on the frequency of a most frequent motion vector among the motion vectors; and
determining whether a tripod had been used based on the determined motion based on the most frequent motion vector.

11. The method of claim 9, wherein the detecting of the reference block comprises:
setting up a region around a block of the current image that is located where the reference block in the previous image is located; and
detecting a block in a current image that is most similar to the reference block, by using a sum of absolute differences (SAD) within the set region in the current image.

12. The method of claim 9, wherein the calculating comprises:
counting a number of blocks detected from among the entire blocks, the detected blocks that are the most similar to reference block; and
calculating amount of change in locations of the counted blocks in the current image as compared to locations of the blocks in the previous image.

13. The method of claim 12, wherein the determining of whether there is local motion comprises:
when the frequency of a most frequent motion vector among the motion vectors is equal to or greater than a first reference value, determining that there is no local motion; and
when the frequency of the most frequent motion vector among the motion vectors is between the first reference value and a second reference value, determining that there is a local motion.

14. The method of claim 13, wherein the determining of whether a tripod had been used comprises:
when it is determined that there is no local motion and the most frequent motion vector indicates no motion, determining that there is no global motion and a tripod had been used;
when it is determined that there is no local motion and the most frequent motion vector indicates motion, determining that there is a global motion and no tripod had been used;
when it is determined that there is a local motion and the most frequent motion vector indicates no motion, determining that there is no global motion and a tripod had been used; and
when it is determined that there is a local motion and the most frequent motion vector indicates motion, determining that there is a global motion and no tripod had been used.

15. A non-transitory computer readable storage medium having stored thereon a computer program executable by a processor for performing a method of controlling a digital image processing apparatus, the method comprising determining a global motion indicating movement of a digital image capturing apparatus and a local motion indicating movement of a portion of an image based on motion information obtained by matching blocks of time-differential images, and determining whether a tripod had been used based on the determined motion.

16. The non-transitory computer readable storage medium of claim 15, wherein the method further comprises:
splitting a previous image and a current image into a predetermined number of blocks;
detecting a reference block that corresponds to a block selected in the previous image, within a predetermined region of the current image;
calculating a motion vector of a block that is most similar to the reference block;
calculating frequencies of the motion vectors, for all blocks in the current image;
determining whether there is a local motion in the current image based on the frequency of a most frequent motion vector among the motion vectors; and
determining whether a tripod had been used based on the determined motion.

17. The non-transitory computer readable storage medium of claim 16, wherein the method further comprises:
setting up a region around a block of the current image that is located where the reference block in the previous image is located; and
detecting a block that is most similar to the reference block based on a sum of absolute differences (SAD) within the set region.

18. The non-transitory computer readable storage medium of claim 16, wherein the method further comprises:
counting a number of blocks detected from among the entire blocks, the detected blocks that are the most similar to the reference block; and
calculating amount of change in locations of the counted blocks in the current image as compared to locations of the blocks in the previous image.

19. The non-transitory computer readable storage medium of claim 18, wherein method further comprises:
determining that there is no local motion when the frequency of a most frequent motion vector among the motion vectors is equal to or greater than a first reference value,
determining that there is no global motion and a tripod had been used when it is determined that there is no local motion and the most frequent motion vector indicates no motion,
determining that there is a global motion and no tripod had been used when it is determined that there is no local motion and the most frequent motion vector indicates motion.

20. The non-transitory computer readable storage medium of claim 19, wherein the method further comprises:
determining that there is a local motion when the frequency of the most frequent motion vector is between the first reference value and a second reference value,
determining that there is no global motion and a tripod had been used when it is determined that there is a local motion and the most frequent motion vector indicates no motion, and
determining that there is a global motion and no tripod had been used when it is determined that there is a local motion and the most frequent motion vector indicates motion.
